(19) United States
(12) Patent Application Publication
(10) Pub. No.: US 2004/0118022 A1
(43) Pub. Date: Jun. 24, 2004

(54) Method and apparatus for beverage merchandising

(76) Inventor: Brad Duesler, Middleton, WI (US)

Correspondence Address: FOLEY & LARDNER, 150 EAST GILMAN STREET, P.O. BOX 1497, MADISON, WI, 53701-1497, US

(21) Appl. No.: 10/679,705

(22) Filed: Oct. 3, 2003

Related U.S. Application Data
(60) Provisional application No. 60/416,153, filed on Oct. 4, 2002.

(51) Int. Cl. G09F 3/00

(52) U.S. Cl. 40/324; 40/649

(57) ABSTRACT

A method and apparatus for beverage merchandising including an annular collar for the neck of a beverage decanter, such as a coffee carafe, which is able to display text information or pictures along its outside surface. The display of text information or pictures may be performed using a graphical insert, such as paper, inserted into a slot formed along the outside surface of the annular collar.

### CROSS-REFERENCE TO RELATED APPLICATION

This application claims the benefit of provisional patent application No. 60/416,153, filed Oct. 4, 2002, the disclosure of which is incorporated by reference.

### FIELD OF THE INVENTION

The present invention relates generally to the field of food merchandising, and particularly to beverage merchandising.

### BACKGROUND OF THE INVENTION

Merchandising methods and devices have grown increasingly sophisticated in response to evolving customer tastes and competition in crowded marketplaces. Methods and devices for merchandising beverages may increase sales of beverages and associated products by attracting consumers who may be passing by, such as in a gas station, convenience store, mall food court, or fast food store.

A variety of techniques have been developed for beverage merchandising. For example, it is common to place a sign, which may be handwritten or printed, on a stand near a coffeepot or beverage carafe. Some coffee pots are color coded to indicate, for example, whether the coffee in the pot is decaffeinated or regular. However, the practical value of these prior techniques is limited by real-world considerations such as information display capacity, durability, cost, cleanliness, appearance, and space requirements.

For these reasons, a method and apparatus for beverage merchandising including a information display which addresses the shortcomings of the prior art would be useful.

### SUMMARY OF THE INVENTION

The present invention relates to a method and apparatus for merchandising beverages including an annular collar for the neck of a beverage decanter, such as a coffee carafe, which is able to display text information or pictures along its outside surface. The display of text information or pictures may be performed using a strip of sheet material, for example paper, inserted into a slot formed along the outside surface of the annular collar.

Such an annular collar does not consume any additional counter or display space, since the space around the neck of a beverage decanter is normally unused. A preferred embodiment of such an annular collar may be inexpensive to manufacture using a semi-rigid material, such as plastic, forming an annular collar which is durable, easy to clean, and attractive in appearance.

According to another aspect of the invention, a timer or other electronic device may display information which changes over time, for example the time a pot of coffee was brewed, the current time, news information, or the like.

Further objects, features, and advantages of the invention will be apparent from the following detailed description when taken in conjunction with the following drawings.

### BRIEF DESCRIPTION OF THE DRAWINGS

In the drawings:

FIG. 1 is a side view of a beverage decanter bearing an embodiment of an annular collar for information display according to the invention.

FIG. 2 is a front perspective view of the annular collar for information display of FIG. 1.

FIG. 3 is a rear perspective view of the annular collar for information display of FIG. 1.

FIG. 4 is a side view of the neck of a beverage decanter bearing another embodiment of an annular collar for information display according to the invention.

FIG. 5 is a side view of the annular collar for information display of FIG. 4.

FIG. 6 is a cutaway view of the annular collar for information display of FIG. 4.

FIG. 7 is a top view of a beverage decanter bearing the annular collar of FIG. 1.

FIG. 8 is a cross-sectional view of the beverage decanter bearing an annular collar of FIG. 7 along the line 7-7 thereof.

FIG. 9 is a perspective view of the annular collar for information display of FIG. 1 including a graphic insert.

FIG. 10 presents a block diagram of exemplary circuitry for use in an annular collar for information display according to the invention.

### DETAILED DESCRIPTION OF THE INVENTION

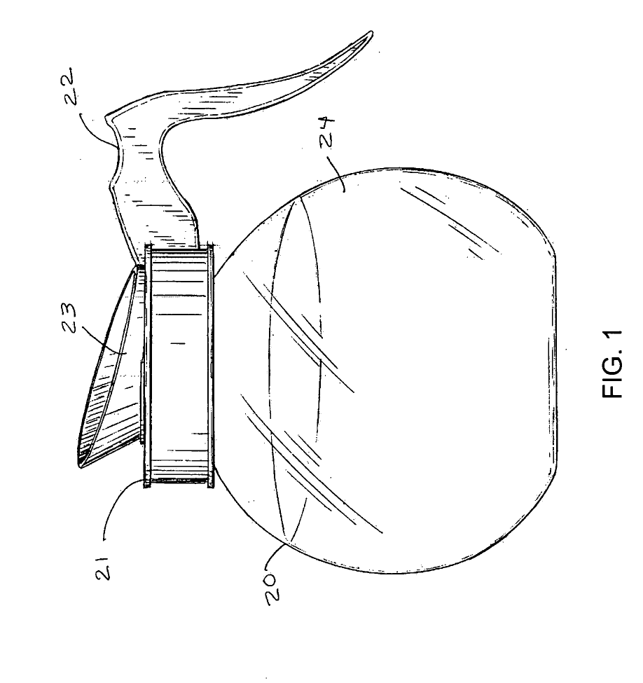

With reference to the drawings, FIG. 1 shows a side view of a beverage decanter, indicated generally at 20, bearing a preferred embodiment of an annular collar for information display according to the invention, indicated generally at 21. The annular collar 21 is preferably shaped to snugly fit the neck 23 of the beverage decanter 20, and may include a gap 33 (not shown in FIG. 1) in the annular collar for a handle 22 of the beverage decanter 20. The beverage decanter 20 preferably contains a beverage 24, for example coffee.

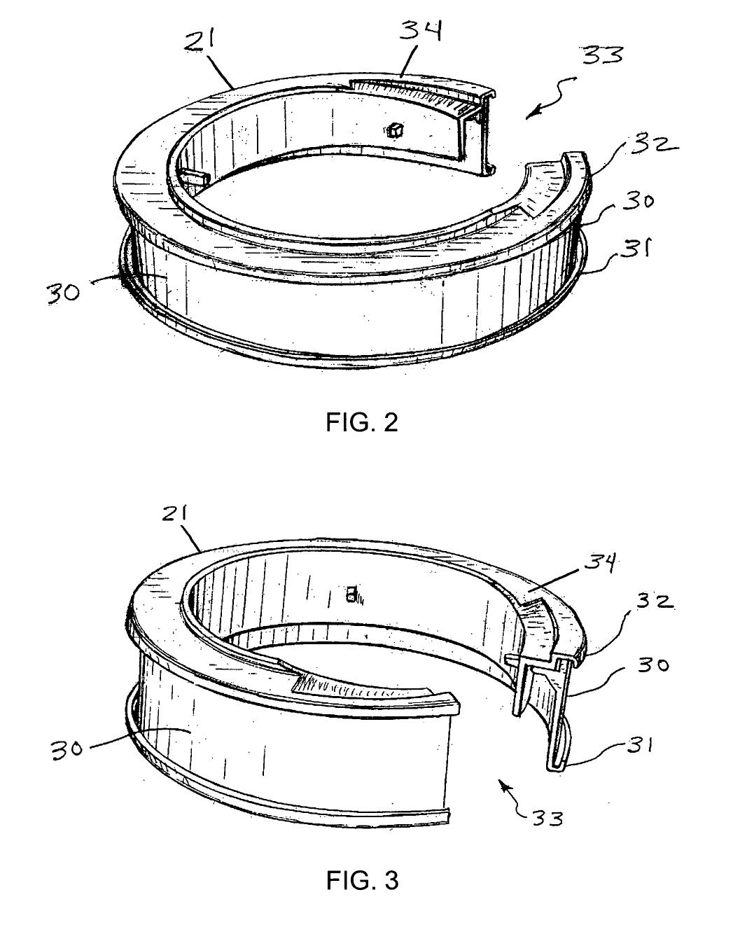

FIGS. 2 and 3 show perspective views of the annular collar 21. The annular collar 21 has an information display surface 30, a lower lip 31, an upper lip 32, and an upper surface 34. A gap 33 in the annular collar may be provided, for example to receive the handle of a beverage decanter.

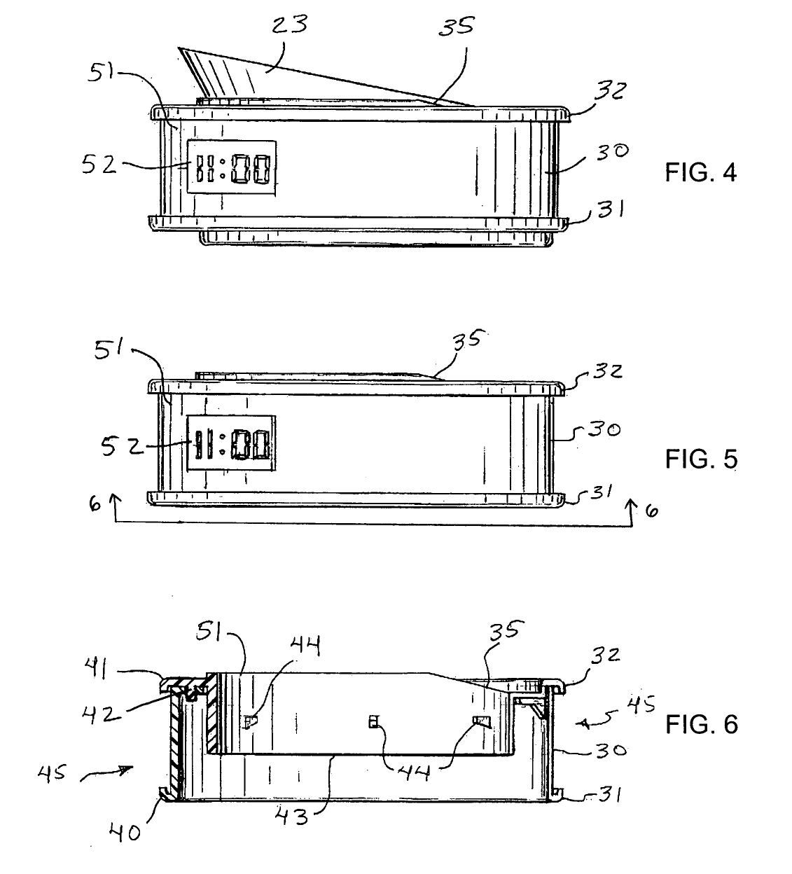

FIG. 4 shows another embodiment of an annular collar 51 for information display according to the invention fitted around the neck 23 of a beverage decanter. The annular collar 51 preferably has a recessed area 35 which allows the annular collar 51 to fit more closely when the neck 23 of the beverage decanter is tapered. FIG. 5 provides the same view as FIG. 4 without the beverage decanter.

As shown in FIGS. 4 and 5, an annular collar 51 according to the invention may include an alphanumeric display 52, for example a liquid crystal display (LCD) or light emitting diode display (LED) or other display capable of displaying information which changes with time, such as the time a pot of coffee was brewed, the current time of day, the date, news, or other information. The alphanumeric display 52 can be used to present information, for example to attract and retain consumers in the vicinity of the annular collar 51, thereby increasing the likelihood that such consumers will make a purchase.

The cutaway view of FIG. 6 shows that the annular collar 51 for information display according to the invention may be formed of an upper piece 41 and a lower piece 40, which may be bonded together, for example using one or more heat stakes 42. The upper piece 41 and the lower piece 40 are preferably made of a durable, flexible material, for example thermoplastic formed using an injection molding process. As best shown in FIG. 6, the upper piece 41 may include the upper lip 32, the recessed area 35, and an inside lower edge 43, while the lower piece may include the lower lip 31 and the information display surface 30. The upper piece 41 may optionally include one or more spacers 44, which may be trimmed to allow the annular collar 51 to fit beverage decanters having necks of various sizes.

As best shown in the cutaway view of FIG. 6, the upper lip 32, the information display surface 30, and the lower lip 31 form a slot, indicated generally at 45. A graphic insert 46 (not shown in FIG. 6), for example paper, bearing printed text or pictures may be inserted into the slot 45, to indicate, for example, the type, brand, or flavor of beverage contained in the decanter. In a preferred embodiment, the upper lip 32 and the lower lip 31 retain the graphic insert 46 in the slot 45.

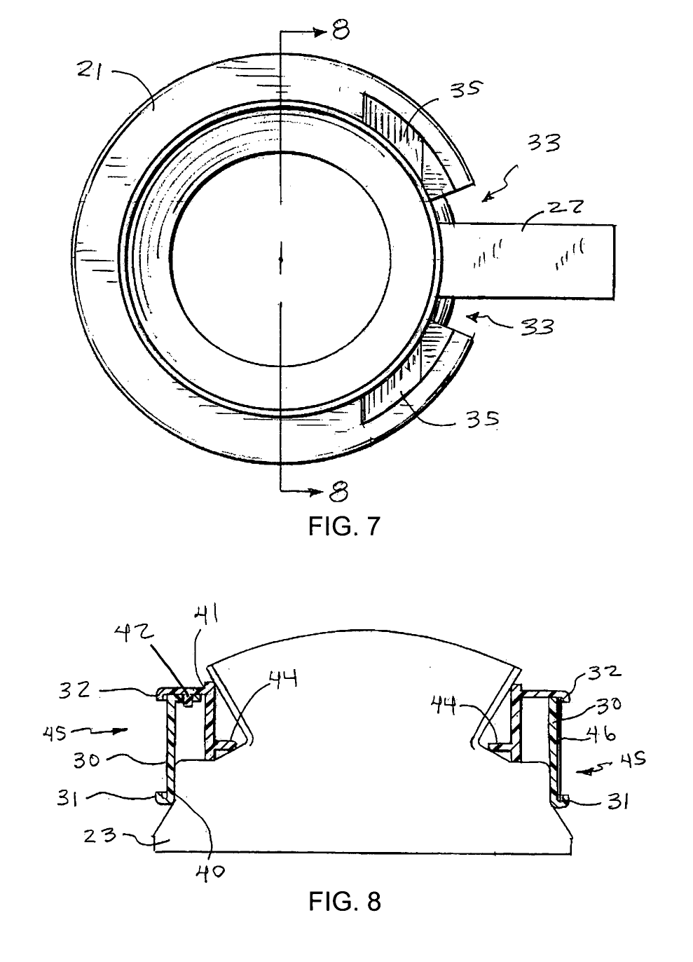

FIG. 7 shows a top view of a beverage decanter bearing an annular collar 21 of FIG. 1. As shown in FIG. 7, the handle 22 of the annular collar 21 may extend through the gap 33. Recessed areas 35 may be provided to allow the annular collar 21 to fit beverage decanters having tapered necks.

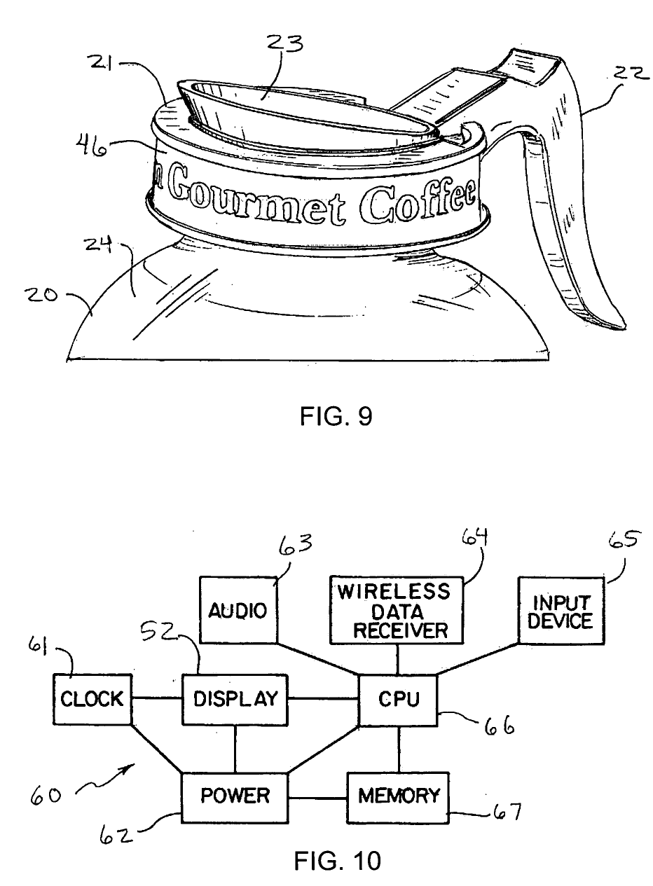

FIG. 8 shows a cross-sectional view of a beverage decanter bearing an annular collar 21 for information display according to the invention. FIG. 9 is a perspective view of the annular collar 21. As shown in FIGS. 8 and 9, a graphic insert 46 may be inserted into the slot 45, to provide information on the information display area 30.

FIG. 10 presents a block diagram of exemplary circuitry, indicated generally at 60, for use in an annular collar for information display according to the invention. The exemplary circuitry 60 may include clock circuitry 61, for example a quartz clock circuit of the type used in wristwatches or household timers. The exemplary circuitry 60 may include a power source 62, for example a battery or solar cell. The exemplary circuitry 60 may include one or more user interface devices, for example one or more audio devices 63, for example a speaker and amplifier of the types used in portable electronic devices, one or more alphanumeric displays 52, and one or more user input devices 65, for example a pushbutton switch used to reset a timer when a fresh pot of coffee is brewed. The exemplary circuitry 60 may also include computer circuitry, for example a central processing unit (CPU) 66, memory 67, for example random access memory or non-volatile memory such as an EPROM or EEPROM, and a wireless data receiver 64, for example an 802.11b network interface device that can be used, for example, to receive news information.

There are various possibilities with regard to alternative embodiments and methods including an annular collar for information display according to the invention.

For example, the annular collar may include a timer or other electronic display in order to indicate, for example, the time the beverage was brewed, current events or news, prices or promotions relating to the beverage or related products such as newspapers or pastries, or other information.

Similarly, the annular collar may be formed in other constructions. For example, the annular collar may be formed of more than two pieces, or extruded as a single piece.

It is understood that the invention is not confined to the embodiments set forth herein as illustrative, but embraces all such forms thereof as come within the scope of the following claims.

What is claimed is:

1. An method for merchandising beverages comprising:
(a) providing a beverage decanter having a neck;
(b) providing an collar forming at least a portion of an annulus and having an information display surface;
(c) providing a graphic insert;
(d) mounting the collar on the neck of the beverage decanter; and
(e) positioning the graphic insert on the information display surface.

2. The method of claim 1 wherein the graphic insert bears information about a beverage.

3. The method of claim 2 wherein the beverage has a flavor name, and the information borne by the graphic insert includes the flavor name of the beverage.

4. An apparatus for merchandising beverages comprising a collar forming at least a portion of an annulus, having an information display surface with an upper end and a lower end, a lower lip connected to the lower end of the information display surface, an upper lip connected to the upper end of the information display surface, with a slot formed between at least a portion of the information display surface, at least a portion of the lower lip, and at least a portion of the upper lip.

5. The apparatus of claim 4 further comprising a graphic insert positioned within at least a portion of the slot.
